(19) United States
(12) Patent Application Publication
(10) Pub. No.: US 2025/0387837 A1
(43) Pub. Date: Dec. 25, 2025

(54) ADDITIVE MANUFACTURING PROCESS USING PULSED LASER RADIATION

(71) Applicant: EOS GMBH ELECTRO OPTICAL SYSTEMS, Krailling (DE)

(72) Inventors: Sebastian EDELHÄUSER, Zorneding (DE); Florian GÜNTHER, Egling (DE)

(21) Appl. No.: 18/880,260

(22) PCT Filed: Jun. 30, 2023
(86) PCT No.: PCT/EP2023/067968

§ 371 Date: Dec. 30, 2024

(30) Foreign Application Priority Data
Jul. 1, 2022 (DE) 10 2022 206 773.8

(51) Int. Cl. B22F 12/43; B22F 10/28; B22F 12/90; B33Y 10/00; B33Y 30/00

(52) U.S. Cl. CPC B22F 12/43; B22F 10/28; B22F 12/90; B33Y 10/00; B33Y 30/00; B22F 2301/15; B22F 2998/10; B22F 2999/00

(57) ABSTRACT

An additive manufacturing method includes applying a layer of building material on a support or a layer of building material that has been previously selectively solidified, selectively solidifying the layer of building material by supplying laser radiation to positions in the layer that are assigned to a cross-section of the object in this layer in that these positions are scanned with a laser beam along a number of trajectories in order to melt the building material along these trajectories, and repeating the two steps of applying a layer and solidifying said layer until the cross-sections of the object that are to be manufactured by additive manufacturing have all been selectively solidified. Pulsed laser radiation is used for melting the building material and the laser beam can be moved across the layer of building material with a speed exceeding 1000 mm/s.

The present invention refers to an additive manufacturing method using pulsed laser radiation.

Additive manufacturing apparatuses and corresponding methods can be generally characterized by the fact that objects are manufactured by a solidification of a shapeless building material layer by layer. The solidification can for example be effected by supplying heat energy to the building material by irradiating the same with electromagnetic radiation or particle radiation (e.g. laser sintering (SLS or DMLS) or laser melting or electron-beam melting). For example, in laser sintering or laser melting, a laser beam is moved across those positions of a layer of the building material that correspond to a cross-section of the object to be manufactured in this layer, so that the building material is solidified at these positions.

FIG. 7 shows the conventional approach in additive manufacturing of objects by means of irradiation of a building material with electromagnetic radiation or particle radiation (e.g. laser sintering (SLS or DMLS)) or laser melting or electron-beam melting). In FIG. 7, an object cross-section 50 is divided into an inner region or core region 52 and a contour region 51, wherein usually for the energy input into the building material other parameters are assigned to the contour region 51 then to the inner region 52. For example, the contour region 51 is scanned with a laser beam such that the laser beam is moved along the course of the contour. Usually, the inner region 52 is solidified by dividing the inner region 52 into partial regions 53 that usually have an approximately rectangular or quadratic shape and thus are also designated as “stripes” or “squares”. The inner region 52 then is scanned with the laser beam partial region by partial region.

As shown in FIG. 7, in each partial region 53, the laser beam is moved across the building material along substantially parallel paths (hatch lines) 54, resulting in a hatch-like movement pattern of the laser beam. In technical jargon, this process is termed “hatching”. Here, in FIG. 7 the movement direction of the laser beam is illustrated by arrows. It can be seen that the movement directions for neighbouring hatch lines 54 are opposed to each other. However this is not mandatory.

As is known from standard laser welding, depending on the laser power, there exist two different modes of melting the material by the laser radiation, which are conduction mode welding for low energy input or keyhole mode welding for sufficiently high energy input. In selective laser melting, in which usually a metal-based building material, often powder material, is used, usually the goal is to melt the material as completely as possible by means of the laser beam, so that in the art frequently a keyhole welding process is aimed at during movement of the laser beam across the building material.

In keyhole welding or deep welding, a melt pool consisting of molten material is formed, which has a depth extension that is larger than the thickness of a layer of freshly applied unsolidified building material (“layer thickness”), for example by a factor of two or three. The extension of such melt pool, however, also defines a lower limit for a resolution of details of an object to be produced, which cannot be compensated by e.g. a smaller movement velocity of the laser beam in order to increase detail resolution. There can be no details that are smaller than an extension of the melt pool within the plane of a layer of building material.

In view of such problem in the prior art, it is an object of the present invention to provide an additive manufacturing method and a corresponding additive manufacturing apparatus, by which objects can be produced with a higher resolution of details, and/or which allow for a shorter manufacturing time, in particular a high movement velocity of the beam in laser sintering or melting, without concessions in detail resolution.

The object is achieved by an additive manufacturing method according to claim 1 and an additive manufacturing apparatus according to claim 9. Further developments of the invention are claimed in the dependent claims. In particular, a device according to the invention can be developed further also by features of the methods according to the invention characterized further below and in the dependent claims, respectively, and vice-versa. Moreover, the features described in connection with one device of the invention may also be used for a further development of another device according to the invention, even if this is not explicitly stated.

An inventive additive manufacturing method for manufacturing a three-dimensional object comprises:
applying a layer of building material on a support or a layer of building material that has been previously selectively solidified,
selectively solidifying the layer of building material by supplying laser radiation to positions in the layer that are assigned to a cross-section of the object in this layer in that these positions are scanned with a laser beam along a number of trajectories in order to melt the building material along these trajectories, and
repeating the two steps of applying a layer and solidifying said layer until the cross-sections of the object that are to be manufactured by additive manufacturing have all been selectively solidified.

It is characterized in that pulsed laser radiation is used for melting the building material along at least one of the trajectories, wherein the laser beam is moved across the layer of building material with a speed exceeding 1000 mm/s.

Additive manufacturing apparatuses and methods to which the present invention refers are in particular those, in which energy is selectively supplied to a layer of a shapeless building material by means of laser radiation. Of course, it is possible to use not only one laser beam, but a plurality of laser beams that may in particular work in parallel for a selective supply of laser radiation to positions in a layer of building material. The radiation supplied to the building material heats the same and thereby effects a sintering or melting process. An application of the invention in connection with additive manufacturing methods and apparatuses, in which a metal or at least metal-containing building material such as a metal powder or metal alloy powder is used, is of particular advantage.

It shall be mentioned here that by an additive manufacturing apparatus or method it is possible to manufacture not only one object at a time, but also a plurality of objects that are simultaneously manufactured. If in the present application the manufacturing of an object is mentioned, it is self-evident that the respective description is in the same way applicable also to additive manufacturing methods and apparatuses, in which several objects are manufactured at the same time.

Here, the term “beam” is used instead of “ray” in order to express the fact that the diameter of the ray impinging on the material within an area of incidence is usually not point-like.

A trajectory corresponds to a scan path (or scan line) specified for a laser beam within a plane that coincides with the plane of the layer of building material to be selectively solidified or is in parallel thereto. A movement of the laser beam across the layer of building material along a trajectory corresponds to a movement of the area of incidence of the laser beam on the layer of building material, which produces a solidification path in the layer of building material. Such a solidification path may be regarded as a line-shaped region in the layer of building material, in which the scanning of the building material by the laser beam causes a melting of the building material and not only a heating of the same. When the building material has been melted, the components of the building material (e.g. powder grains) coalesce, so that after cooling the building material exists as a solid. A solidification path may e.g. be a straight line segment of a certain width, along which the building material is melted during scanning. However, there are also cases in which one or more changes of direction occur when a beam is moved along a trajectory, so that the solidification path can become e.g. a curved line of a certain width.

It should be mentioned that there may be building materials such as alloys, for which no unique melting point but a melting interval is defined. In principle, in such a case one may speak of a (partial) melting already when the solidus temperature, i.e. the lower limit of the melting interval, is exceeded. However, the present invention is preferably applied to cases in which the building material is completely melted, i.e. the liquidus temperature or the upper limit of the melting interval is exceeded.

Since the transitions between partial melting or liquid phase sintering (with superficial melting of powder grains when the building material is in powder form) and complete melting are fluid, the terms sintering and melting are used synonymously in the present application. In any case, the present invention can be specifically applied in additive manufacturing apparatuses, in which a complete melting of the building material, in particular by means of a keyhole welding process, occurs when a beam is directed to the building material.

When the building material is scanned along a trajectory, the extension of the area of incidence of the laser beam perpendicular to the movement direction of the laser beam, meaning the beam width, will have an influence on the width of the resulting solidification path. Such width of the solidification path corresponds to the dimension of the melt pool generated by the laser radiation perpendicular to the movement direction of the laser beam.

In general, the present invention can be applied to any trajectory in the plane of the layer of building material, in particular to hatch lines that are used for an areal solidification of regions, but also to the contour of an object cross-section.

Pulsed laser radiation here means that during movement of the laser beam the laser power supplied to the building material is not continuous, in particular not constant over time. In particular, this applies to laser radiation supplied in pulses, for which a repetition frequency and a pulse length can be defined.

According to the present invention, in contrast to the prior art, the laser radiation used for selectively melting the building material is not continuous wave radiation. Rather, instead of a laser source with continuous wave (CW) emission, a laser source with pulsed wave (PW) emission is used. In addition, the laser beam (meaning the area of incidence of the laser beam on the building material) is moved with a speed exceeding 1000 mm/s. Surprisingly, it results that by such measures it is possible to produce structures with dimensions that are smaller than the ones that can be obtained in the prior art, where continuous wave (CW) emission is used and the laser beam is moved with a limited speed under the intention of generating a melt pool as uniform as possible while moving the laser beam along a trajectory. By the inventive approach it becomes possible to generate structures having a minimum dimension in the same order as the dimension of the area of incidence of the laser beam on the building material.

In particular, the inventive approach has the benefit that the step of selectively solidifying a layer of building material can be carried out faster as the laser beam is moved faster across the building material, leading to a shorter manufacturing time.

Finally, the inventors have observed that a reduction of the laser power leads to a reduction of the structure dimension that can be produced. As when using pulsed radiation, the power supply to the material is discontinuous, a better resolution of details also results from the reduced power input. Under a different view, this means that the same resolution of structures as in the prior art can be achieved even when a laser having a higher laser power is used.

Preferably, the laser beam is moved across the layer of building material with a speed exceeding 1200 mm/s, preferably 2000 mm/s, more preferably 3000 mm/s, even more preferably 3800 mm/s.

The inventors observed that there were no drawbacks when the speed by which the laser beam is moved across the layer of building material was increased. In contrast to this, in the prior art, where a continuous wave laser beam is moved across the building material, an elongation of the melt pool is observed for high scan speeds. such elongation of the melt pool is known to promote instabilities such as the Kelvin Helmholtz hydrodynamic instability (also known as ‘humping’) and the Plateau Raleigh capillary instability (also called ‘balling effect’). Thus, in the prior art, the speed of movement of the laser beam has to be limited, so that the speed of movement of the laser beam (scanning speed) is one of the limiting and most influential variables on the process behavior in continuous mode laser sintering or melting. Thus, the present invention allows for a remarkably shorter manufacturing time of the objects than the approach in the prior art.

Further preferably, the laser beam is moved across the layer of building material with a speed that is lower than 8000 mm/s, preferably lower than 6000 mm/s, more preferably lower than 5000 mm/s.

Of course, there must exist a maximum speed of movement of the beam that should not be exceeded. Accordingly, the given maximum values for the speed of movement are recommended.

Preferably, along the trajectory by each two successive laser pulses two melt pools separated from each other are generated.

Here, a melt pool is considered as an amount of material that has been melted by means of a laser beam and is in a liquid state, in which it is able flow, thus change its position. As soon as material has cooled down so much that it is no longer able to flow it is no longer considered to belong to a melt pool. Thus, when two melt pools are separated from each other, this means that they are disconnected in that there exists material between them that is not able to flow or move and prevents the two melt pools from merging into one single melt pool.

According to the invention, smaller minimum dimensions of object details are achievable even for higher speeds of movement (scanning speeds) than in the prior art. Here, investigations by the inventors have shown that the pulsed laser radiation leads to a significantly different process behavior than in the case of the conventional process with continuous laser radiation. This difference in process behaviour can mainly be ascribed to the observation that the process results are primarily determined by the building-up of the individual melt pools formed by the periodic supply and interruption of the energy input when using pulsed laser radiation. It is assumed that when using pulsed laser radiation, each pulse leads not yet to the formation of an extended melt pool in an equilibrium state as would be the case for continuous radiation, but rather leads to the formation of a pre-stage of a melt pool resembling the build-up phase of a melt pool at the start of a trajectory when using continuous laser radiation, wherein there already exists material in a molten state, but the melt pool is still growing. When pulsed radiation is applied, such pre-stages of melt pools are created periodically along the whole length of a trajectory.

Thus, while the process behavior and process results in conventional continuous mode laser sintering or melting (continuous mode laser powder bed fusion) are mainly characterized by the welding regime, the building-up time of a melt pool is characterizing the process behavior as well as the process results in pulsed mode laser sintering or melting. For this reason, parameters such as the speed of movement of the laser beam (scan speed) affect the process differently in pulsed mode laser sintering or melting.

It is assumed that when using pulsed radiation, there is no significant elongation of the melt pool, because there is not enough time for the melt pool to be built up to relevant dimensions. This also means that effects triggered by elongation of the melt pool and thus by scanning speed, which limit the additive manufacturing process when using continuous laser radiation, may not occur in a process using pulsed laser radiation.

As a result of the above-mentioned investigations, it was found that for satisfying results in the manufacturing of objects, the irradiation of the material with the laser beam should lead to a pre-stage of the melt pool (see above) but not yet to the full formation of a melt pool. This can be achieved by choosing the parameters in the pulsed laser radiation (pulse frequency, duty ratio, speed of movement, et cetera) such that there is no significant elongation of the melt pool because there is not enough time for the melt pool to be built up to relevant dimensions. This means that the parameters should be chosen such that neighbouring melt pools that are formed by subsequent laser pulses should not merge to form an elongated common melt pool. Having in mind that a continuous solidification path can only be obtained by continuously melting the building material along the course of the solidification path, this can be achieved as follows: The (liquid) melt pools achieve their maximum extension not at the same time. Rather, at any moment in time they are separated from each other by material that is not able to flow preventing a merging of the melt pools. In other words, there is no merging, because the melt pools do overlap in space but do not overlap in time. Alternatively, in particular when more than one laser beam is used in the building process, it is possible that pulses overlap in time, while they do not overlap in space, such that the formation of an elongated common melt pool can be avoided also in this case. This can be achieved with an appropriate choice of parameters, as outlined above.

Preferably, at the start of the second pulse, the melt pool corresponding to the previous pulse does no longer exist. This means that the material in the melt pool corresponding to the previous pulse is no longer liquid, meaning it is no longer able to flow in that it has already sufficiently solidified.

In particular, it is not intended to move a melt pool along the course of the solidification path as it is done when using continuous-mode laser radiation. Accordingly, the solidification can be controlled by an appropriate selection of the parameters of the pulsed laser radiation.

In a preferred modification of the inventive method, pre-tests with the intended beam power and speed of movement of the beam can be carried out, in which the building material is observed using a high-speed camera (e.g. IR camera). Thereby, it can be observed, whether neighbouring melt pools that correspond to two successive laser pulses do touch or in other words merge.

Further preferably, the at least one trajectory is a first trajectory located in a first layer of building material and a second layer is applied on the first layer, wherein a second trajectory is located in the second layer substantially above and in parallel to the trajectory, wherein pulsed radiation is used for melting the building material along the second trajectory, wherein laser pulses are applied between each two successive laser pulses in the first trajectory.

The term “substantially above and in parallel” here means that the second trajectory is either exactly above the first trajectory in the first layer or is shifted perpendicular to the course of the first trajectory by an amount that is less than half of the distance between the trajectories in the first layer. Here, the distance is meant to be the distance between two neighbouring trajectories perpendicular to the course of the trajectories assumed to be running in parallel to each other

By such a strategy, it is possible to build e.g. thin walls that do nevertheless have sufficient mechanical strength, in particular a sufficient density of the solidified material. However, also for object portions other than thin walls this can be advantageous as it allows e.g. for a reduction of the manufacturing time. Of course, one could repetitively apply the strategy, wherein a third layer is applied on the second layer, a third trajectory is located in the third layer substantially above and in parallel to the second trajectory, pulsed radiation is used for melting the building material along the third trajectory and along the third trajectory laser pulses are applied between each two successive laser pulses in the second layer and so on for further layers.

Further preferably, the at least one trajectory is a first trajectory located in a first layer of building material, wherein a second trajectory is located in the first layer such that it is substantially overlapping and in parallel to the first trajectory, wherein pulsed radiation is used for melting the building material along the second trajectory and wherein laser pulses of the second trajectory are applied between each two successive laser pulses of the first trajectory.

The term “substantially overlapping and in parallel” here means that the second trajectory is either exactly overlapping the first trajectory in the first layer or is shifted perpendicular to the course of the first trajectory by an amount that is less than half of the distance of the trajectories in the first layer.

Accordingly, a solidification path in one layer is formed by scanning the building material along such solidification path twice or more times. This can be implemented by means of two or more trajectories substantially overlapping each other and in parallel to each other, wherein by the second, third, etc. trajectory laser pulses are applied between each two successive laser pulses in the previous trajectory.

Preferably, pulsed laser radiation with pulse lengths smaller than 500 μs, preferably smaller than 200 μs, even more preferably smaller than 100 μs, still more preferably smaller than 40 μs, still more preferably smaller than or equal to 10 μs and pulse lengths larger than 1 μs, more preferably larger than 5 μs, still more preferably larger than or equal to 10 μs is used.

It was observed that the minimum dimensions of the objects that were achievable started to decrease as soon as the pulse length became smaller than 500 μs. However, the smaller the pulse length was chosen, the smaller the achievable minimum dimensions were. It should also be mentioned that the laser off time τ_{off} that is correlated with the pulse length τ via τ_{off}=1/f−T (f: pulse frequency) is preferably chosen such that the duty ratio τ/(τ+τ_{off}) is larger than 10% and/or smaller than 50%, preferably larger than 10% and/or smaller than 30%, more preferably larger than 12% and/or smaller than 20%.

Preferably, the beam power is larger than 100 W, preferably larger than 500 W, still more preferably larger than 1000 W, even more preferably larger than 2000 W and the beam power is smaller than 10000 W, more preferably smaller than 5000 W.

The term “beam power” here refers to the radiant power incident on the building material, when the laser beam is directed onto the building material. In case only one beam is used for solidifying the building material, the beam power corresponds to the power of the laser light emitted by a laser source assuming that there are no losses on the optical components between the laser source and the building material. Of course, in case there are power losses, these power losses have to be subtracted from the power output of the laser source in order to obtain the beam power.

High beam powers, in particular those that are larger than or equal to 1000 W, can be used in particular when the movement speed of the beam exceeds 3000 mm/s and the lengths of the laser pulses are smaller than 50 μs. In such case the amount of energy that is introduced into the material is limited due to the pulsed radiation in spite of the high beam power. However, using a high beam power has advantages with respect to e.g. beam shaping. In particular, with a high beam power a large beam spot can be generated, by means of which an area of a building material layer can be solidified in shorter time. However, a large melt pool that results when a large beam spot is used and continuous radiation is used cannot move so fast. Due to the use of pulsed radiation this problem is alleviated.

Preferably, said at least one trajectory is located on a portion of the previous layer of building material that previously has been scanned with a laser beam along a number of trajectories in order to melt the building material within said portion.

In such a case, when the laser beam is incident on the building material of the actual layer for scanning positions to be solidified, the energy introduced into the building material by the radiation leads to a melting of the material. However, in this approach the material that is melted is located on a portion of the previous layer that has already been solidified and thus has a higher heat conductivity than not yet solidified material. Accordingly, the time needed for a formation of a melt pool will become longer. As a result, the extension of the melt pool is limited, helping in particular in the formation of small structures (thin walls, spikes, protrusions, small bridges, etc.), in particular also when a high movement speed of the laser beam is applied.

Conventionally, a difference is made in the production process between portions of a layer of building material that during solidification thereof by the laser beam are located above unsolidified material (designated as “downskin” regions) and portions of a layer of building material that during solidification thereof with the laser beam are located above already solidified material (designated as “inskin” regions (or “topskin” regions in case these portions after solidification will be covered with material that will not be solidified)). Accordingly, the inventive approach is preferably applied to both inskin regions and topskin regions, and more preferable to only inskin regions.

It shall be remarked that sometimes the term “downskin region” is extended to those portions to be solidified of a layer, for which in at least one of p layers underneath no building material was solidified, wherein p is a predefined integer larger than zero. P usually is a value smaller than 10, preferably smaller than 6. With such an extended definition of downskin regions, the inventive approach is preferably applied to portions to be solidified of a layer, for which in all of p layers beneath the building material has been solidified, p being again an integer larger than zero, which is preferably smaller than 10 and more preferably smaller than 5. One should also have in mind here that the keyhole formed during irradiation with continuous laser radiation differs from the keyhole formed when using pulsed radiation and may e.g. penetrate 3 to 9 layers, wherein a keyhole formed by pulsed laser radiation would penetrate e.g. only half as much layers such as 4-5 layers.

### Wiederholung des Wortlauts der Ansprüche 11 bis 13

Preferably the overlap O of the areas of incidence of the beams corresponding to two successive pulses in the scan direction corresponds to O=(d−s_{off})/d, wherein Soff corresponds to the distance in the scan direction over which the laser is off and d corresponds to the diameter of each of the areas of incidence.

When determining the overlap O in this way, the overlap value is independent from the pulse duration and accordingly leads to a more realistic determination of the overlap leading to a more precise determination of the laser parameters of the pulsed laser radiation.

Further preferably, d corresponds to the diameter of the melt pool perpendicular to the scan direction resulting from each of the two successive pulses.

When choosing d to be the melt pool diameter, an even more realistic model for setting the laser pulse parameters is taken into consideration as the melt pool diameter need not necessarily be identical to the diameter of the area of incidence of the laser radiation. Accordingly, it is possible to more precisely adjust the energy input and radiation power, so that more precise object details can be produced faster.

Further preferably, a value larger than −300% and preferably smaller than −200% is set for the overlap of two consecutive pulses in the scan direction.

An inventive additive manufacturing apparatus for manufacturing a three-dimensional object comprises:
an application device for applying a layer of building material on a support or a layer of building material that has been previously selectively solidified,
a solidification device for selectively solidifying the layer of building material by supplying laser radiation to positions in the layer that are assigned to a cross-section of the object in this layer in that these positions are scanned with a laser beam along a number of trajectories in order to melt the building material along these trajectories, and
a control device configured to repeat the two steps of applying a layer and solidifying said layer until the cross-sections of the object that are to be manufactured by additive manufacturing have all been selectively solidified.

It is characterized in that the solidification device is configured to supply pulsed laser radiation for melting the building material along at least one of the trajectories and the control device is configured to move the laser beam across the layer of building material with a speed exceeding 1000 mm/s.

An inventive layer-wise additive manufacturing apparatus may in particular be configured to carry out an inventive layer-wise additive manufacturing method and may in particular be a laser sintering apparatus or laser melting apparatus.

Further features and experiences of the invention result from the description of exemplary embodiments by means of the attached drawings.

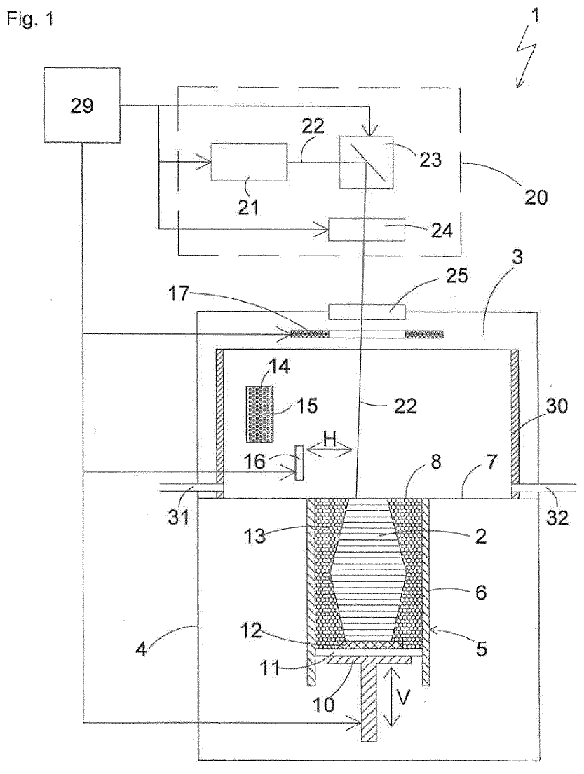

FIG. 1 shows a schematic, partially sectional view of an exemplary device for an additive manufacture of a three-dimensional object according to an embodiment of the invention.

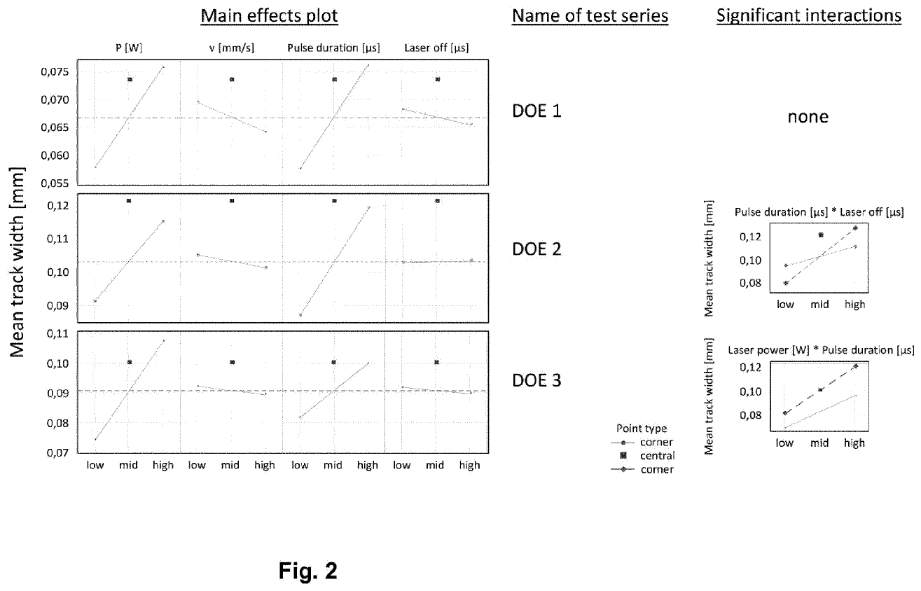

FIG. 2 shows exemplary parameters for the pulsed laser radiation resulting from the inventors' investigations.

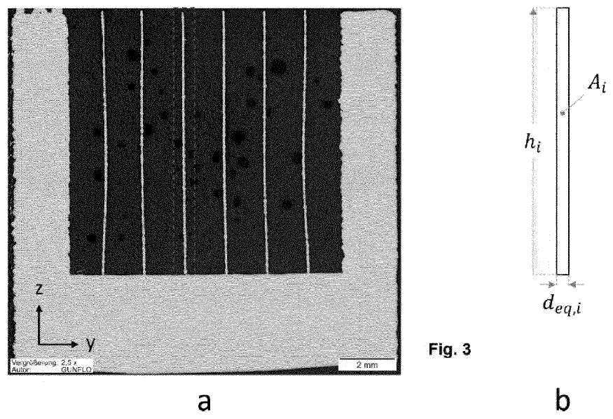

FIG. 3 illustrates how structural dimensions of test specimen can be determined.

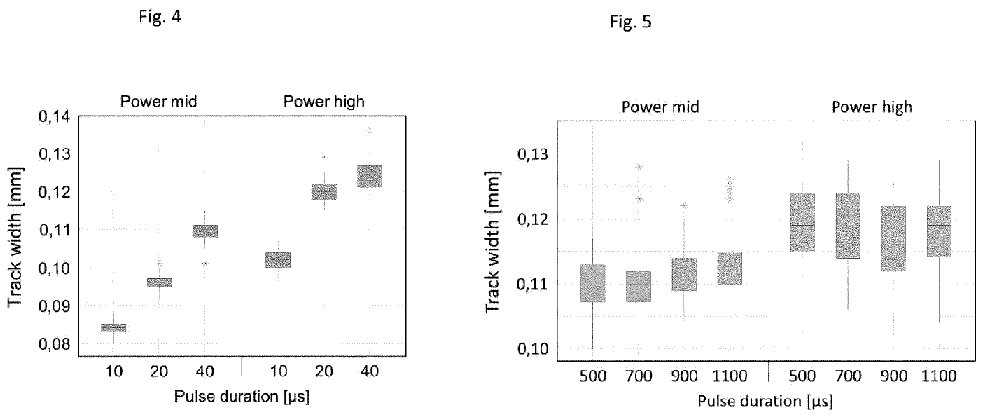

FIG. 4 shows the dependence of the track width on the pulse length.

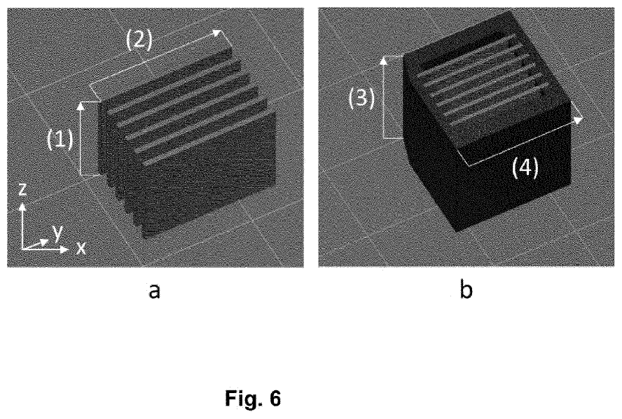

FIG. 5 shows the dependence of the track width on the pulse length for a different temporal range than the one of FIG. 4.

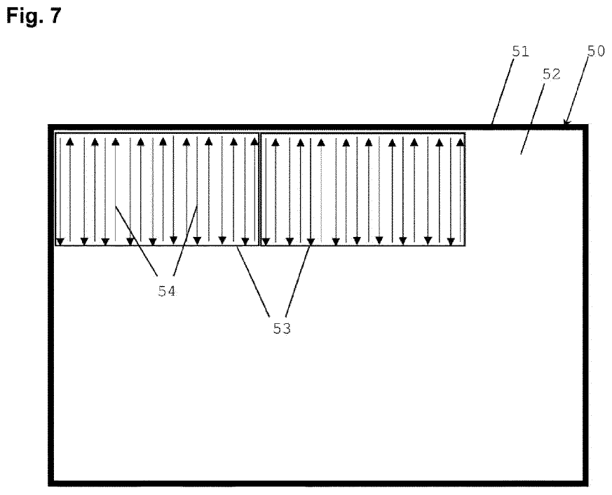

FIG. 6 shows samples that were investigated in order to determine the track widths.

FIG. 7 shows a conventional approach for solidifying a portion of an object cross-section.

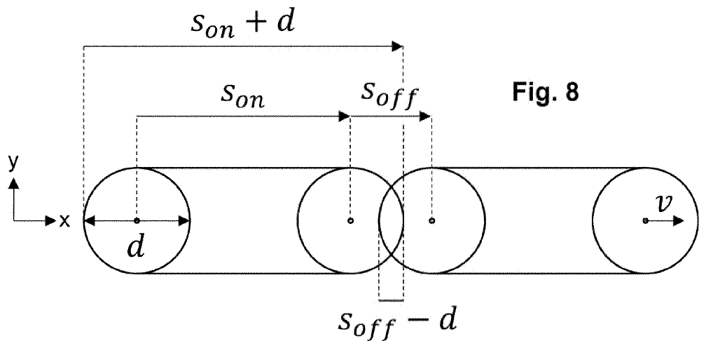

FIG. 8 is a schematic illustration of the areas of incidence corresponding to two subsequent laser pulses.

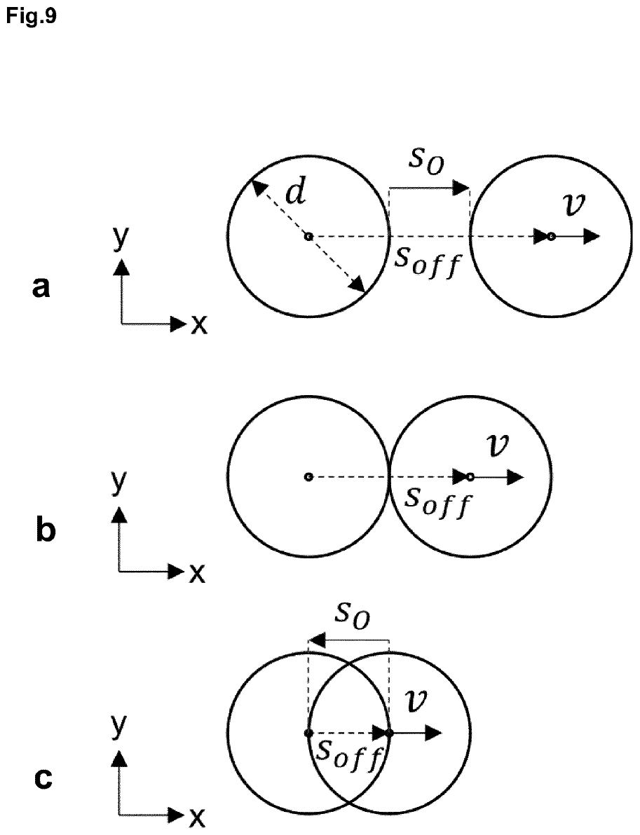

FIG. 9 illustrates different possibilities for an overlap of two consecutive pulses.

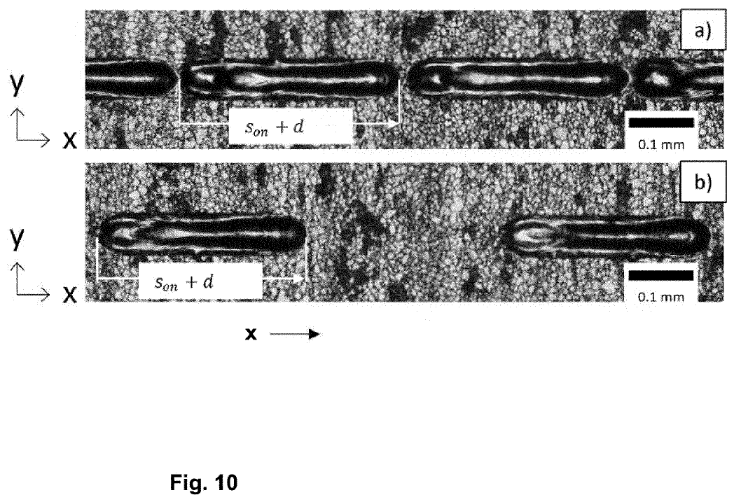

FIG. 10 shows a sample with two different melt tracks resulting from two sets of laser parameters that differ in the pulse lengths specified for two consecutive laser pulses.

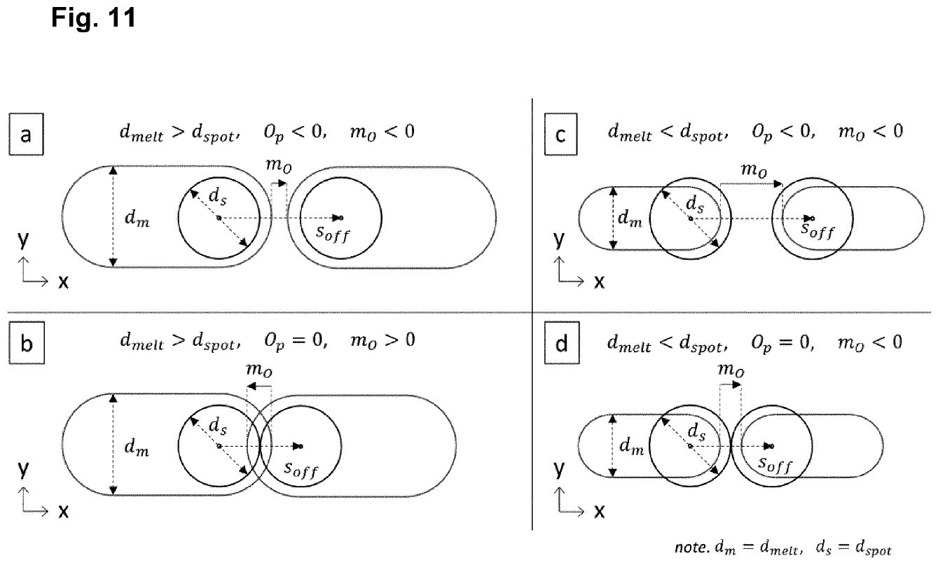

FIG. 11 illustrates the extensions and the positions of the areas of incidence and of the melt pools for a particular trajectory that can result for different energy beam parameters.

In the following, for a description of the invention at first an additive manufacturing apparatus according to the invention shall be described at the example of a laser sintering apparatus or laser melting apparatus with reference to FIG. 1.

For building an object 2, the laser sintering or laser melting apparatus 1 comprises a process chamber or build chamber 3 having a chamber wall 4. A build container 5 open to the top and having a container wall 6 is arranged in the process chamber 3. A working plane 7 (also termed building plane) is defined by the top opening of the build container 5, wherein the area of the working plane 7 located within the opening, which area can be used for building the object 2, is referred to as build area 8.

In the build container 5, a support 10 is arranged, which can be moved in a vertical direction V and to which a base plate 11 is attached that seals the container 5 at the bottom and thus forms the bottom thereof. The base plate 11 can be a plate formed separately from the support 10, which is fixed to the support 10, or it can be integrally formed with the support 10. Depending on the powder and process used, a building platform 12 as building support on which the object 2 is built can be additionally arranged on the base plate 11. However, the object 2 can also be built on the base plate 11 itself, which then serves as a building support. In FIG. 1, the object 2 to be formed in the container 5 on the building platform 12 is shown below the working plane 7 in an intermediate state with several solidified layers, surrounded by building material 13 that remained unsolidified.

The laser sintering or melting apparatus 1 further comprises a storage container 14 for a building material 15, in this example a powder that can be solidified by electromagnetic radiation, and a recoater 16 that can be moved in a horizontal direction H for applying building material 15 within the build area 8. Optionally, a heating device, e.g. a radiant heater 17, can be arranged in the process chamber 3 for heating the applied building material. For example, an infrared heater can be provided as radiant heater 17.

The exemplary additive manufacturing apparatus 1 further comprises an energy input device 20 having a laser 21 generating a laser beam 22 that is deflected by a deflection device 23, e.g. one or more galvanometer mirrors with a dedicated drive, and focused on the working plane 7 by a focusing device 24 through a coupling window 25 that is arranged at the top side of the process chamber 3 in the chamber wall 4.

The energy input device can for example comprise one or more gas or solid-state lasers or any other laser types such as laser diodes, in particular VCSEL (Vertical Cavity Surface Emitting Laser) or VECSEL (Vertical External Cavity Surface Emitting Laser) or a line of these lasers. Therefore, the specific setup of a laser sintering device or laser melting device shown in FIG. 1 is only exemplary for the present invention and may of course be modified, in particular when using a different energy input device than the one that is shown. In order to indicate that the area of the area of incidence of the radiation on the building material need not necessarily be very small (“point-shaped”), in this application usually the term “beam” is used synonymously to “ray”.

The laser sintering apparatus 1 additionally comprises a control device 29, by which the individual components of the apparatus 1 can be controlled in a coordinated manner in order to carry out the building process. Alternatively, the control device can also be arranged in parts or completely outside of the additive manufacturing apparatus. The control device can comprise a CPU, the operation of which is controlled by a computer program (software). The computer program can be stored separate from the additive manufacturing apparatus in a storage device from where it can be loaded (e.g. via a network) into the additive manufacturing apparatus, in particular into the control device. In the present application, the term “control device” refers to any computer-based control device that is able to control the operation of an additive manufacturing apparatus and in particular also the operation of components thereof. Here, the connection between the control device and the controlled components need not necessarily implemented by means of cables but can also be implemented in a wireless way using e.g. radio communication, WLAN; NFC, Bluetooth or the same with the control device comprising corresponding receivers and emitters.

In operation, for applying a layer of the building material, at first the support 10 is lowered by an amount that corresponds to the desired layer thickness. Then the recoater 16 is moved across the build area and applies there a layer of the building material 15 onto the support or an already existing layer of the building material that has already been selectively solidified. Then, the cross-section of the object 2 to be manufactured is scanned with the laser beam 22, so that the building material 15 in powder form is solidified at those positions that correspond to the cross-section of the object 2 to be manufactured. Thereby, the powdered reins at these positions are melted by the energy introduced by the radiation, so that after calling-down they exist connected to each other in a solid state. These steps are repeated until the object 2 is finished and can be removed from the process chamber 3.

When metal-containing building materials are irradiated with the laser beam in order to melt the same, often splashes, smoke, vapour is and/or gases are generated that spread into the process chamber and may affect the manufacturing process. in order to avoid such adverse effects on to the manufacturing process, the laser melting apparatus 1 may optionally contain a gas flow device 30 having a gas supply 31 and a gas outlet 32, by which a flow of process gas (also designated as flow of protective gas) is generated across the build area 8. Preferably, a laminar gas flow is generated above the working plane seven, wherein the speed and direction parallel to the working plane 7 can be fixed or optionally can be changed by means of the control device 29.

Of course, modifications of the just-described additive manufacturing apparatus, which is only a specific example, are possible. The skilled person will immediately recognize that the set-up of e.g the energy input device 20 and/or the arrangement and setup of the deflection device 23 might also be different. In particular, also a plurality of lasers 21 and/or deflection devices 23 could be used as well.

According to a first embodiment, objects are manufactured by means of a laser sintering apparatus using metal-based powder as building material. The powder material can be e.g. a nickel-alloy-powder such as the one distributed under the brand name IN718 by the applicant. Such material is a gas atomized powder in compliance with UNS N07718, AMS 5662, AMS 5664, W.Nr2.4668 and DIN NiCr19Fe19NbMo3 and has a particle size distribution ranging from 20 μm to 55 μm (see e.g. EOS NickelAlloy IN718 Material Data Sheet (2021) (https://www.eos.info/en/additive-manufacturing/3d-printing-metal/dmls-metal-materials/nickel-alloys). TABLE I. gives the nominal chemical composition as percentage weight (wt.-%).

TABLE I
CHEMICAL COMPOSITION OF EOS
NICKELALLOY IN718 (IN WT.-%)

Chemical Composition

| | | |
|---|---|---|
| Element | Min. | Max. |

| | |
|---|---|
| Fe | Rem. |

| | | |
|---|---|---|
| Ni | 50.00 | 55.00 |
| Cr | 17.00 | 21.00 |
| Nb | 4.75 | 5.50 |
| Mo | 2.80 | 3.30 |
| Ti | 0.65 | 1.15 |
| Al | 0.20 | 0.80 |
| Co | — | 1.00 |
| Cu | — | 0.30 |
| Si | — | 0.35 |
| Mn | — | 0.35 |
| Other | — | 0.17 |

An additive manufacturing apparatus that can be used is for example the EOS M 290 laser sintering system that is distributed by the applicant. Such a system uses a 400 W Yb fiber laser with a wavelength of 1070 nm as energy input device. During manufacturing, an argon gas atmosphere is provided with a maximum of 0.1% residual oxygen. Such a gas atmosphere is able to reduce adverse effects due to splashes, smoke, vapour and/or gases that are generated during the building process. As building platform temperature, 80° C. can be used. The standard layer thickness (thickness of a newly applied layer of building material) is 40 μm.

With the above-mentioned EOS M290 system, the inventors investigated the effect of individual exposure parameters on the width of an actual solidification path (track width). In order to do so, the laser beam was directed to the stainless steel building substrate without building material in the build container 5. Pulsed laser radiation was applied, wherein the laser power P supplied by the laser source 21, the pulse length T, the laser off time (which for a given pulse frequency is correlated with the duty ratio) and the speed of movement of the laser beam (scanning speed) were varied as parameters. All in all, three statistical experimental designs (DoE 1, DoE 2, DoE 3) were used, wherein for each combination of parameter values the track width was determined.

FIG. 2 gives an overview of the results for different parametric ranges. When moving the beam across the steel substrate, the track width was mainly affected by changes of the laser power P and pulse duration τ (both marked with *). Two significant interactions were found between laser power (beam power) P and pulse duration (pulse length) τ as well as between pulse duration τ and laser off time τ_{off}, wherein the laser off time T_{off} corresponds to 1/f−τ (f: pulse frequency). The pulse duration was also part of both identified parameter interactions with the laser off time and laser power, respectively. Meanwhile, the scan speed was found to have no statistically significant influence on the track width, meaning there is no drawback when the scan speed (movement speed of the beam) is increased. On the contrary, it seemed that for pulsed laser radiation the track widths became slightly smaller when the scan speed was increased.

The investigated samples manufactured from IN718 consisted of six single walls, which were scanned with pulsed laser radiation, and a protective housing to protect the filigree structures during the recoating process (see FIG. 6). The housing part of the sample was scanned using continuous wave laser radiation. The intended dimensions of the structures to be seen in FIG. 6 are as follows: (a) dimensions of the walls: (1) wall height: 9.5 mm, (2) wall length: 12 mm. (b) dimensions of the housing: (3) height: 14.5 mm, (4) length of edge: 14 mm. In TABLE II, the parameters used for this investigation can be found.

TABLE II

Range

| Parameter | Min. | Max. |
|---|---|---|
| P [W] | 120 | 370 |
| v [mm/s] | 1000 | 4000 |
| E_{L} [mJ/mm] | 92.5 | 120 |
| τ [μs] | 10 | 300 |
| τ_{off} [μs] | 90 | 500 |
| Oₗᵢₜₑᵣₐₜᵤᵣₑ [%] | 6 | 78 |

Here, P designates the beam power, v designates the speed of movement of the beam across the building material, E_{L} designates the linear heat input along the scan direction, τ designates the pulse length and Oₗᵢₜₑᵣₐₜᵤᵣₑ designates the overlap of the areas of incidence of the beams corresponding to two successive pulses in the scan direction.

FIG. 8 schematically illustrates the areas of incidence corresponding to two subsequent laser pulses. It is assumed that at each instant, the area of incidence of the beam is circular-shaped with a diameter d of the circle. The laser is ON during the pulse length τ resulting in a distance sₒₙ=v·τ (v being the movement speed (in mm/s) of the beam on the material) that the area of incidence on the building material moves during the time τ in the scan direction x. From this, a theoretical extension of the area covered by the beam on the building material during the pulse length is sₒₙ+d. The overlap Oₗᵢₜₑᵣₐₜᵤᵣₑ (in %) can then be calculated according to the formula well-known from literature

$${O}_{l i t e r a t u r e} = 1 - v / [ f \cdot ( v \cdot ⊤ + d ) ] , \qquad ( 1 )$$

where f is the pulse frequency (in Hz), τ is the pulse length (in μs), v is the movement speed (in mm/s) and d is the diameter of the beam on the building material (approx. 80 μm, assumed to be circular).

In a further development of the invention, the inventors used a different definition of the overlap O, in spite of the fact that formula (1) is common in the literature. The reason for this is that by using formula (1) the pulse overlap may be underestimated for relatively long pulse durations. This could lead to the use disadvantageous parameters, in order to (wrongly) increase the overlap more than necessary, when aiming to produce continuous melt tracks:

Substituting the pulse frequency f with the pulse period T in (1) leads to:

$${O}_{literature} = 1 - vT / ( v ⊤ + d ) ; or analogously : \qquad ( 2 )$$

$${O}_{literature} = ( v ⊤ + d ) / ( v ⊤ + d ) - vT / ( v ⊤ + d ) = ( v ⊤ + d - vT ) / ( v ⊤ + d ) = [ d - v ( T - ⊤ ) ] / ( v ⊤ + d ) ; further considering {s}_{off} = v ( T - ⊤ ) and {s}_{on} = v ⊤ :$$

$${O}_{literature} = ( d - {s}_{off} ) / ( d + {s}_{on} ) .$$

The expression (2) for the overlap is equivalent to (1). From (2) it becomes evident that the overlap calculated based on (1), or analogously (2), depends on both the distance over which the laser in switched on (son) and the distance over which the laser is switched off (s_{off}). This means, for example, that calculating the overlap according to (1), and analogously (2), will render for a long distance (sₒₙ), for which the laser is switched on, a small overlap, even if the actual overlap area between two consecutive pulses is large. Accordingly, the inventors have modified (1) and (2) neglecting the dependence on the distance sₒₙ for which the laser is switched on, resulting in a dependence of the overlap O only on the distance over which the laser is off Soff and on the pulse diameter d.

$$O = ( d - {s}_{off} ) / d \qquad ( 3 )$$

In equation (3), a negative value for the pulse overlap O will result, if the successive pulses do not touch each other (see FIG. 9a). A pulse overlap O of 0 means that the pulses touch but do not overlap (see FIG. 9b). A positive value for the pulse overlap O will result, if the successive pulses do actually overlap (see FIG. 9c). Note that in FIGS. 9a to 9c the symbol s_{O} designates d−s_{off}.

FIGS. 10a) and 10b) show test results, wherein the effect of a positive or negative overlap on the melt track is illustrated. Like in FIGS. 9a to 9c, the x axis is the scanning direction of the beam

Table III presents preferable parameters when using a definition according to (3) for the pulse overlap. In the set of parameters presented in Table III, a large negative overlap, for example up to −294%, can be reached because the denominator in (3) is smaller than the denominator in (2). Considering only the pulse diameter (d) and the distance over which the laser is switched off (s_{off}) when setting the pulse overlap, i.e., setting the pulse overlap according to (3), allows for a better control of the melt tracklength.

In FIG. 10a), the melt track is obtained by using a positive overlap value of 56%, while in FIG. 10b) the melt track is obtained by using a negative overlap of −294%. It can be seen that despite the different overlap values, the melt tracks in FIGS. 10a) and 10b) have different lengths, while they have the same width. The different lengths can be explained in consideration of the pulse overlap as defined in (3), where the overlap O only depends on the diameter (d) of the area of incidence and on the distance s_{off} over which the laser is switched off. Due to the positive overlap O in FIG. 10a), the laser hits a preheated area of the substrate when it is switched on again. This causes the melt pool to build up faster and the expansion in exposure direction is increased. On the other hand, a negative overlap O in FIG. 10b) causes the laser to hit cold substrate when it is switched on again. As a result, the build-up of the melt pool is delayed in time and space, and the expansion of the molten pool in the scanning direction x is reduced. Furthermore, when using the overlap definition according to (3), an overlap value can be set without substantially changing the pulse duration τ. In contrast to this, the overlap calculated according to (1) has a dependence on the pulse duration. Therefore, the melt width is substantially not affected by a variation of the pulse overlap as calculated based in (3).

TABLE III

Range

| Parameter | Min. | Max. |
|---|---|---|
| P [W] | 120 | 400 |
| v [mm/s] | 1000 | 3000 |
| E_{L} [mJ/mm] | 30 | 400 |
| τ [μs] | 10 | 300 |
| τ_{off} [μs] | 10 | 90 |
| O [%] | −294 | 90 |

Up to now, it was assumed that the diameter d or dₛₚₒₜ of the beam on the building material (meaning of the area of incidence on the building material) corresponds to the diameter of the melt pool dₘₑₗₜ that is created by the incident radiation. However, in practice this need not be the case.

FIG. 11 illustrates the extensions and the positions of the areas of incidence and of the melt pools for a particular trajectory that can result for different energy beam parameters. Note that dₘₑₗₜ relates to the extension of the melt pool perpendicular to the scanning direction.

In FIGS. 11a and 11b, the parameters are chosen such that the melt pool diameters dₘₑₗₜ perpendicular to the scan direction are larger than the (substantially circular) diameters dₛₚₒₜ of the areas of incidence. It can be seen from FIG. 11b that there is a spatial overlap m_{O} of the melt pools even if the areas of incidence do not overlap, but do only touch (O=0). In contrast to this, the situation of FIG. 11a is unfavorable. With no spatial overlap of the melt pools there can be no continuous solidification path unless there is an overlapping trajectory by which the “gaps” are filled.

FIGS. 11c and 11d illustrate a situation, in which the parameters are chosen such that the melt pool diameters dₘₑₗₜ are smaller than the diameters dₛₚₒₜ of the areas of incidence. It can be seen from FIG. 11d that even when the areas of incidence touch each other, the melt pools do not yet touch, meaning that the parameters are unfavorable even for the case of FIG. 11d as no continuous solidification path will result unless there is an overlapping trajectory by which the “gaps” are filled.

It was mentioned that the situations shown in FIGS. 11a, 11c and 11d would be unfavorable as no continuous solidification path would result. This, however, does not apply when either using two or more overlapping trajectories, each of which is scanned using pulsed radiation:

For example, when having a trajectory with spaced melt pools as shown in FIG. 11c, this will be no problem, if in the next layer of building material above thereof there is a trajectory in which the melt pools overlay the interspaces between the melt pools in the trajectory beneath. The reason for this is that usually a melt pool extends to a depth, which is a multiple of the thickness of one layer of building material. Having in mind such large extension of the melt pools, one could even achieve continuous melt tracks, if the melt pools in a trajectory in the next but one layer overlay the interspaces between the melt pools in the trajectory below.

Also, it is possible to apply overlapping trajectories in one and the same layer. Referring by way of example again to the situation shown in FIG. 11c, this means that one could scan the layer along another trajectory, resulting also in spaced melt pools as shown in FIG. 11c. When doing so, no problem with regard to a continuous melt track will occur, if the two trajectories overlap such that the melt pools of the second trajectory overlay the interspaces between the melt pools in the first trajectory.

In view of the fact that a melt pool has a non-zero extension perpendicular to the scanning direction and of the fact that regions of a building material layer are hatched such that there is a full coverage of the area (meaning two adjacent trajectories in the layer plane are so close to each other that there are no regions of unsolidified material between them), it is not necessary for two overlapping trajectories in one layer to overlap completely. In the same way, it is not necessary that trajectories in different layers above one another need to be positioned exactly above of each other for obtaining continuous melt tracks. Rather, satisfactory results with regard to melt track continuity can be obtained even when the two trajectories are shifted perpendicular to the scan direction by less than half of the distance between adjacent trajectories.

Preferably, the melt pool diameters dₘₑₗₜ perpendicular to the scanning direction should be used in equation (3). Such diameters are experimentally accessible by the test results shown in FIGS. 10a) and 10b) as the extensions of the melt pools perpendicular to the scanning direction are directly accessible to measurements.

Stated in other words, when pulsed laser radiation is applied and the overlap values specified in Table Ill above are used, where the overlap O has been calculated using equation (3), wherein the melt pool diameters dₘₑₗₜ perpendicular to the scanning direction have been used in equation (3), it is possible to obtain structure dimensions (e.g. wall thicknesses) that are smaller than the ones achievable by the use of continuous laser radiation.

The test samples manufactured from IN718 were prepared as follows:

Polished cross sections of the specimens were made in order to analyze the walls. Specimen halves (cut transversely to the walls) were embedded in epoxy resin (ClaroCit). Grinding was performed using SiC (200 μm) and diamond (220 μm) grinding mediums followed by polishing using 9 μm and 3 μm diamond suspensions and 50 nm silicon oxide polishing solution (OPS).

The optical analysis then was done as follows:

A light microscope (Olympus GX51) was used to examine the polished cross sections of the walls. The equivalent wall thickness d_{eq} was used for the evaluation. For this purpose, the cross-sectional area Aᵢ and the height hᵢ of each individual wall was measured (see FIG. 3). FIG. 3(a) shows a light microscope image of a polished specimen cross section. In the red marked area there is an exemplary wall, which is shown schematically in FIG. 3(b). FIG. 3(b) shows how a wall cross section is approximated by a rectangle. The equivalent wall thickness of the wall i was calculated to be d_{eq,i}=Aᵢ/hᵢ.

The effect of the pulse duration τ on the track width, which was identified as a main effect in the statistical experimental designs, is presented as a boxplot in each of FIGS. 4 and 5. As shown in FIG. 4, an increase of the pulse duration τ from 10 μs to 40 μs leads to an increase of the track width from approx. 84 μm to 110 μm in case of medium laser power P and from approx. 102 μm to 124 μm in the case of a high laser power P. A variation of the pulse duration τ in the range between 500 μs and 1100 μs, on the other hand, led to relatively constant values for the track width with deviations from the median of approx. 5 μm in case of a medium laser power P and approx. 4 μm in case of a high laser power P (see FIG. 5).

Accordingly, there is a dependence of the track width on the pulse duration, which is particularly strong for short pulse durations of 10 μs to 40 μs. It is assumed that this can be explained by the fact that the measured track widths in this range correlate with different states during the build-up phase of the melt pool. Since long pulse durations (pulse lengths) are comparable to continuous wave exposures, the decreasing dependence of a track width on the pulse duration can be explained. In summary, in pulsed operation mode the pulse duration is decisive for the effective melt pool state.

While prior art processes using continuous laser radiation aim at establishing a specific welding regime for melting the building material (conduction mode welding or keyhole mode welding), the approach according to the present invention, which uses pulsed radiation, leads to different process conditions. This can be explained as follows:

Due to physical boundary conditions, a certain amount of time elapses before such a welding regime is fully established. This is reflected in the dependence of the track width on the pulse length for short pulses, which indicates that the melt pool state is dependent on the pulse length. It can be assumed that short pulses lead to a periodically collapsing pre-stage of a melt pool rather than a completely established welding regime.

Also, it was observed that the scan speed (movement speed of beam across the building material) has no statistically significant influence on the track width of the melt tracks in pulsed operation mode. For example, it was possible to use a scan speed of 4000 mm/s to build 9.5 mm high defect-free walls with a thickness of 78 μm corresponding approximately to the diameter of the region of incidence of the laser beam (80 μm) on the material. This scan speed corresponds to multiple times the standard scan speed used in the prior art for continuous laser radiation. The observation confirms the previously stated hypothesis that scan speed dependent melt pool instabilities, such as balling and humping, as they are observed for continuous laser radiation, may not be a limiting factor when using pulsed laser radiation. In addition, computational fluid dynamics simulations were carried out, which also revealed that humping starts to occur only after approx. 900 μs after the laser has been switched on. Such time period is far longer than the pulse lengths that are recommended in accordance with the present invention. Accordingly, it can be concluded that, especially for short pulses, there is no significant elongation of the melt pool due to the scan speed because there is not enough time for the melt pool to be built up to relevant dimensions.

It shall be remarked that there might even be a slight improvement of detail resolution when the scan speed is increased. For example, for a pulse duration of 150 μs it was observed that defect-free walls having a thickness of 120 μm could be obtained for a scan speed of 1250 mm/s and defect-free walls having a thickness of 80 μm could be obtained for a scan speed of 4000 mm/s.

When a steel powder different from IN718 is used as building material, the parameters to be applied to the pulsed laser radiation should be the ones specified above for the melting point of the other material being similar to that of IN718. What is important is that, as stated above, neighbouring melt pools corresponding to subsequent laser pulses along a trajectory should not merge but stay separated from each other. In principle, one might calculate a sufficient overlap O of the areas of incidence of the beams corresponding to two subsequent laser pulses according to equation (1) given above, however, one should have in mind that equation (1) refers only to the areas of incidence of the laser radiation, which are not necessarily identical to the areas of the corresponding melt pools. The melt pool areas could e.g. also be changed by changing the beam power or the frequency of the laser pulses. Accordingly, it is preferable to choose an experimental approach when switching to a new building material for which there does not yet exist experience as to the laser parameters. For example, a limited number of pre-tests can be carried out with such new building material.

Having in mind the situations illustrated in FIG. 11, it has to be remarked again unless a trajectory overlaps with another trajectory in the same layer or is overlaid by a trajectory in the following layer, there should be a spatial overlap or at least touching of the melt pools along a trajectory in order to guarantee a continuous solidification path, though at each moment in time these melt pools do not touch. Moreover, it can be seen in FIG. 11 that for producing a thin wall, it may be necessary to select the parameters such that the diameters of the melt pools dₘₑₗₜ are smaller than the diameters dₛₚₒₜ of the areas of incidence. However, when doing so, care should be taken that other parameters such as the pulse duration τ or the frequency f of the pulses are chosen such that there still is an overlap of the melt pools unlike the situations shown in FIGS. 11c and 11d.

In the pre-tests, an irradiation of the building material with the intended beam power and speed of movement of the beam can be carried out, wherein the building material is observed using a high-speed camera. Thereby, it can be observed, whether neighbouring melt pools that correspond to two successive laser pulses do touch or in other words merge. The correct parameters then are those, for which there is no merging of the melt pools corresponding to two subsequent pulses along a trajectory. An upper limit for an acceptable distance between the melt pools would be 2-3 time the diameter of the area of incidence of the beam, preferably a distance equal to the diameter of the area of incidence of the beam, further preferably a distance equal to half the diameter of the area of incidence of the beam. Here, one should also have in mind that the melt pools corresponding to two subsequent pulses are not generated at exactly the same time. This means that a melt pool corresponding to the first one of the pulses might already have become smaller because of cooling-down, so that in fact the melt pools do not merge though the areas of incidence corresponding to the two pulses overlap.

Also, one should note that for large distances between the melt pools one should preferably take care that the region between two melt pools is irradiated with the beam in at least one, e.g. the next one, of the following layers in order to provide for a uniform melting/solidification of the material to be solidified. Such an approach provides no difficulty having in mind that the invention is preferably applied to “inskin” regions of the object as defined further above, which are characterized by the fact that in a number of layers above and below such regions the building material is solidified.

It is in particular also possible to set up a number of pre-tests in order to enter the correct parameter values for e.g. the pulse length, the scan speed, the duty ratio or the laser power (beam power) into a database, so that when it is planned to start a manufacturing process all that has to be done is accessing the database for the correct parameter values. A further alternative would be a feedback between camera and laser control (e.g. control device 29), so that the pulse frequency and/or the laser off time (or duty cycle) are automatically changed based on the distance between the melt pools detected by the camera.

Finally, it should be mentioned that though the samples presented had thin walls in order to investigate the resolution of details, the present invention is also applicable to other structures that are more “bulky”. By using pulsed radiation and an increased velocity of movement also for these structures there is the advantageous effect that the manufacturing time is lowered though there are no other drawbacks (e.g. melt pool instabilities) as compared to the prior art.

It shall also be mentioned that the detailed method and apparatus described in the embodiment are only an example. Such example can of course be modified by the skilled person based on his/her professional knowledge and the teaching in the present application. For example, instead of laser light, a different electromagnetic radiation might be used. Furthermore, the use of the indefinite article “a” or “one” does not necessarily rule out that the respective features exist in a plurality. Also, the term “unit” does not necessarily rule out that it has several components interacting with each other, which components may also be located at different places. Finally, the term “a number” is understood to mean “one or more” or “at least one”.

1. An additive manufacturing method for manufacturing a three-dimensional object comprising:
applying a layer of building material on a support or a layer of building material that has been previously selectively solidified,
selectively solidifying the layer of building material by supplying laser radiation to positions in the layer that are assigned to a cross-section of the object in this layer in that these positions are scanned with a laser beam along a number of trajectories in order to melt the building material along these trajectories,
repeating the two steps of applying a layer and solidifying said layer until the cross-sections of the object that are to be manufactured by additive manufacturing have all been selectively solidified,
wherein pulsed laser radiation is used for melting the building material along at least one of the trajectories, wherein the laser beam is moved across the layer of building material with a speed exceeding 1000 mm/s.

2. The method according to claim 1, wherein the laser beam is moved across the layer of building material with a speed exceeding 3800 mm/s.

3. The method of claim 1, wherein the laser beam is moved across the layer of building material with a speed that is lower than 5000 mm/s.

4. The method of claim 1, wherein along the at least one trajectory by each two successive laser pulses two melt pools separated from each other are generated.

5. The method of one of claim 4, wherein at the start of the second pulse, the melt pool corresponding to the previous pulse does no longer exist.

6. The method of claim 4,
wherein the at least one trajectory is a first trajectory located in a first layer of building material and a second layer is applied on the first layer,
wherein a second trajectory is located in the second layer substantially above and in parallel to the first trajectory,
wherein pulsed radiation is used for melting the building material along the second trajectory,
wherein laser pulses are applied between each two successive laser pulses in the first trajectory.

7. The method of claim 4,
wherein the at least one trajectory is a first trajectory located in a first layer of building material,
wherein a second trajectory is located in the first layer substantially overlapping and in parallel to the first trajectory,
wherein pulsed radiation is used for melting the building material along the second trajectory,
wherein laser pulses of the second trajectory are applied between each two successive laser pulses of the first trajectory.

8. The method of claim 1, wherein pulsed laser radiation with pulse lengths smaller than or equal to 10 μs and pulse lengths larger than or equal to 10 μs are used.

9. The method of claim 1, wherein the beam power is larger than 2000 W and the beam power is smaller than 5000 W.

10. The method of claim 1, wherein said at least one trajectory is located on a portion of the previous layer of building material that previously has been scanned with a laser beam along a number of trajectories in order to melt the building material within said portion.

11. The method of claim 1, wherein the overlap O of the areas of incidence of the beams corresponding to two successive pulses in the scan direction corresponds to O=(d−soff)/d, wherein soff corresponds to the distance in the scan direction over which the laser is off and d corresponds to the diameter of each of the areas of incidence.

12. The method of claim 11, wherein d corresponds to the diameter of the melt pool perpendicular to the scan direction resulting from each of the two successive pulses.

13. The method of claim 11, wherein a value larger than −300% and smaller than −200% is set for the overlap of two consecutive pulses in the scan direction.

14. An additive manufacturing apparatus for manufacturing a three-dimensional object comprising:
an application device for applying a layer of building material on a support or a layer of building material that has been previously selectively solidified,
a solidification device for selectively solidifying the layer of building material by supplying laser radiation to positions in the layer that are assigned to a cross-section of the object in this layer in that these positions are scanned with a laser beam along a number of trajectories in order to melt the building material along these trajectories,
a control device configured to repeat the two steps of applying a layer and solidifying said layer until the cross-sections of the object that are to be manufactured by additive manufacturing have all been selectively solidified,
wherein the solidification device is configured to supply pulsed laser radiation for melting the building material along at least one of the trajectories and the control device is configured to move the laser beam across the layer of building material with a speed exceeding 1000 mm/s.
